(19) United States
(12) Patent Application Publication
(10) Pub. No.: US 2015/0312771 A1
(43) Pub. Date: Oct. 29, 2015

(54) SMALL CELL DEPLOYMENT SYSTEMS AND METHODS

(71) Applicant: Alcatel-Lucent USA Inc., Murray Hill, NJ (US)

(72) Inventor: Li Erran LI, Edison, NJ (US)

(21) Appl. No.: 14/261,519

(22) Filed: Apr. 25, 2014

(51) Int. Cl. H04W 16/18; H04W 24/02

(52) U.S. Cl. CPC H04W 16/18; H04W 24/02; H04W 92/16

(57) ABSTRACT

In one example embodiment, a device is configured to determine whether to install a small cell base station at a target location. The device includes a processor configured to determine a transmission record associated with communication between at least one macro cell base station and a plurality of user equipment (UEs), and determine whether to install the small cell base station at the target location based on the transmission record and a connectivity state of each of the plurality of UEs.

### BACKGROUND

Cellular operators have been building out LTE networks rapidly to meet the demand of exponential mobile data growth. Small cells serviced by small cell base stations are considered to be critical in meeting the demand economically. For example, some service providers will deploy small cell base stations in the order of tens of thousands within the next few years. Finding optimal locations for installing these small cell base stations is desirable considering the costs associated with such installations.

Existing approaches for optimizing small cell base station placement include drive test approach, Smartphone App (SA) approach, 3GPP Minimum Drive Test (MDT) approach and in-network per call measurement data with localization (HetNet Ace) approach. These existing approaches are inadequate. For example, drive test approach cannot collect traces for longer durations and many places are not accessible to the driving means (e.g., cars, trucks, etc.). SA approach relies on a user manually providing information, which lacks fine-grained information. SA only identifies coverage problem. The MDT approach currently has limited support because Global Positioning System (GPS) locations are not read very often and are not accurate indoors. Finally, HetNet Ace approach relies on in-network per-call measurement data for UE localization. However, it is well-known that LTE in-network UE localization is not accurate because time-delay information is only available for the serving cell of a user equipment (UE) and the localization accuracy is in hundreds of meters.

Overall, the described existing approaches are inadequate for pinpointing optimal locations for small cell base station deployment.

### SUMMARY

Some example embodiments relate to methods and/or apparatuses to determine an optimal location for deploying a small cell base station.

In one example embodiment, a device is configured to determine whether to install a small cell base station at a target location. The device includes a processor configured to determine a transmission record associated with communication between at least one macro cell base station and a plurality of user equipment (UEs), and determine whether to install the small cell base station at the target location based on the transmission record and a connectivity state of each of the plurality of UEs.

In yet another example embodiment, the processor is configured to determine the transmission record by decoding a plurality of control channels and obtaining information included in each of the plurality of control channels, the obtained information corresponding to the communication between the at least one macro cell base station and the plurality of UEs.

In yet another example embodiment, the obtained information includes one or more of an identification of each of the plurality of UEs, an identification of a cell served by the macro cell base station, uplink and downlink transmissions between the at least one macro cell and the plurality of UEs, coding and modulation schemes for transmitting data between the at least one macro cell base station and the plurality of UEs, allocated resource blocks and success or failure of transmissions between the at least one macro cell base station and the plurality of UEs.

In yet another example embodiment, the processor is further configured to determine a density of active UEs from among the plurality of UEs, a map illustrating a power distribution of the plurality of UEs at the target location and a downlink data volume associated with the plurality of UEs at the target location. The processor determines whether to install the small cell base station at the target location based on the density of active UEs, the map and the downlink data volume.

In yet another example embodiment, the density of active UEs is an average of the active UEs over at least one of a time period and a geographical area.

In yet another example embodiment, the density of active UEs is a moving average of the active UEs over at least one of a time period and a geographical area.

In yet another example embodiment, the downlink data volume is an average downlink data volume associated with each of the plurality of UEs over a time period.

In yet another example embodiment, the downlink data volume is an average downlink data volume associated with all of the plurality of UEs over a time period.

In yet another example embodiment, the device further includes a receiver configured to receive signals transmitted between the at least one macro cell base station and the plurality of UEs, the receiver including a first component for receiving downlink signals transmitted from the at least one macro cell base station to each of the plurality of UEs and a second component for receiving uplink signals transmitted from each of the plurality of UEs to the at least one macro cell base station.

In yet another example embodiment, the device further includes a memory configured to store information related to the communication between the at least one macro cell base station and the plurality of UEs.

In yet another example embodiment, the device further includes a transmitter configured to transmit to a central processor at least one of information related to the communication between the at least one macro cell base station and the plurality of UEs, and a result of determining whether to install the small cell base station at the target location.

In one example embodiment, a system includes a plurality of devices, each of the plurality of devices being deployed at different respective target locations, each target location having an associated set of user equipment (UEs), each of the plurality of devices including a processor configured to, determine a transmission record associated with communication between at least one macro cell base station and the associated set of UEs as well as a connectivity state of each of the plurality of UEs. The system further includes a central processor configured to receive transmission records and the connectivity state of each of the plurality of UEs, from the plurality of devices and determine whether to install a small cell base station at one of the different target locations or another location, based on the received transmission records and the connectivity states of each of the plurality of UEs.

In one example embodiment, a method includes determining a transmission record associated with communication between at least one macro cell base station and a plurality of user equipment (UEs) and determining whether to install the small cell base station at the target location based on the transmission record and a connectivity state of each of the plurality of UEs.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a system in which a device for determining a target location for installing a small cell base station may be used, according to an example embodiment;

FIG. 2 illustrates the components of a monitoring device of FIG. 1, according to an example embodiment;

FIG. 3 is a flow chart describing a process for determining whether a target location is optimal for installing a small cell base station, according to an example embodiment;

FIG. 4 illustrates radio resource control states of a user equipment, according to an example embodiment; and

FIG. 5 illustrates transmission status of a user equipment during a connected radio resource control state, according to an example embodiment.

### DETAILED DESCRIPTION OF EXAMPLE EMBODIMENTS

Various embodiments will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This disclosure may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,’ or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged, and certain operations may be omitted or added to the process. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a non-transitory computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory content. Information, arguments, parameters, data, etc. may be passed, forwarded, or transmitted via any suitable means including memory sharing, message passing, token passing, network transmission, etc.

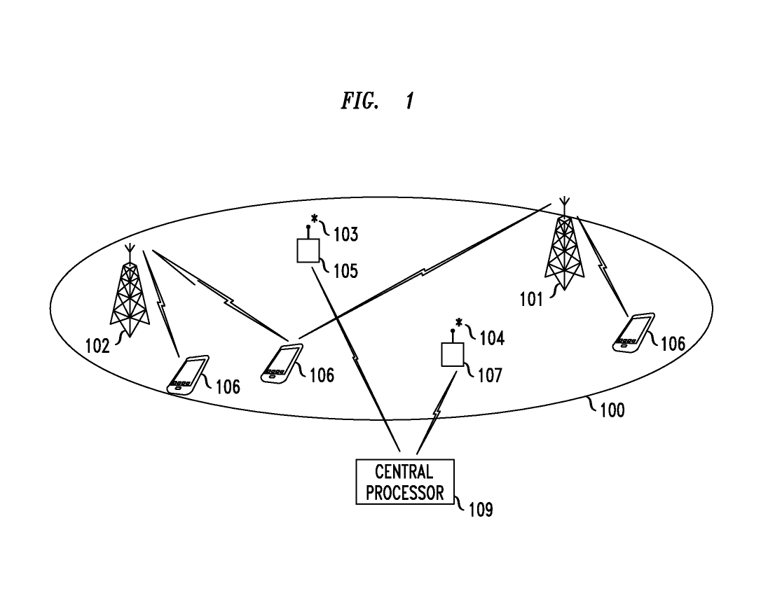

FIG. 1 illustrates a system in which a device for determining a target location for installing a small cell base station may be used, according to an example embodiment. FIG. 1 illustrates a geographical area 100, which may be under coverage of one or more Long Term Evolution (LTE) e-Node Bs 101 and/or 102. Although FIG. 1 illustrates two e-Node Bs, a given geographical area may be under coverage of only one e-Node B and/or any number of e-Node Bs.

The geographical area may be a residential or a commercial building, a shopping center, a museum, a stadium, a small neighborhood or any other location where deployment of small cell base stations may be desirable in order to distribute network traffic, expand network coverage and/or address data demand by users of user equipment (UE) of the network. Furthermore, there may be one or more UEs 106 within the geographical area 100. The geographical area 100 may be a single cell serviced by a single e-Node B or may be an overlap of two or more cells serviced by two or more e-Node Bs such as e-Node Bs 101 and 102.

Within the geographical area 100 of the system shown in FIG. 1, there may be a target location 103. In one example embodiment, an initial assessment may be made (e.g., by a service provider that intends to install a small cell base station within the geographical area 100) as to what locations in the geographical area 100 may be designated as target location 103. The initial assessment may be based on any one or more of the known approaches discussed in the background section above. Although the discussion throughout the present disclosure refers to a single target location 103, in one example embodiment, there may be more than one target location designated within the geographical area 100, such as the target location 104 shown in FIG. 1 or any other number of target locations.

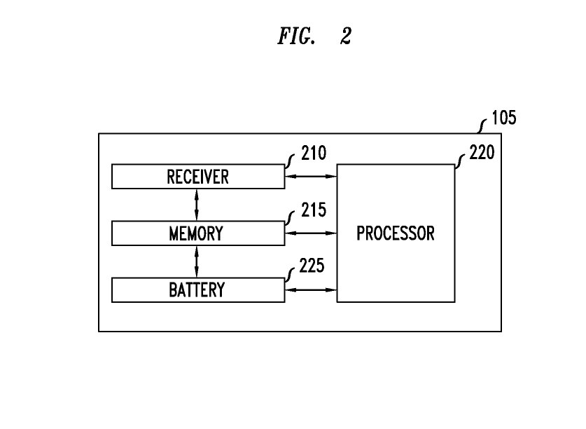

Once the target location 103 is determined, a monitoring device 105 may be deployed at the target location 103 (e.g., by a service provider that intends to install a small cell base station within the geographical area 100). The monitoring device 105, which will be further described below with respect to FIG. 2, may be used to determine whether the target location 103 constitutes an optimal location for installing a small cell base station (e.g., an LTE small cell base station). The monitoring device 105 may also be referred to as a monitoring device and/or an LTEOptinode device.

In one example embodiment, where there is more than one target location in a given geographical area, a monitoring device such as the monitoring device 105 may be deployed at each of the target locations. For example, monitoring device 105 may be deployed at target location 103 and the monitoring device 107 may be deployed at target location 104.

In one example embodiment and as will be described below, data from multiple monitoring devices may be analyzed to determine one of the target locations as the target location to install the small cell base station at, or in the alternative determine another location (e.g., other than target locations 103 and 104) as the location for installing the small cell base station. FIG. 1 further depicts a central processing unit which will be described below.

While hereinafter and in describing the example embodiment, reference is made to e-Node B 101, target location 103 and monitoring device 105, such description may equally be applied to e-Node B 102, target location 104 and monitoring device 107, respectively.

FIG. 2 illustrates the components of a monitoring device of FIG. 1, according to an example embodiment. The monitoring device 105 includes a receiver 210, a memory 215, a processor 220 and a battery 225. The monitoring device 105 may be configured by an operator so as to be capable of being at the target location(s) for a certain period of time ranging from a few days to a few weeks. This range of time varies depending on various factors including, but not limited to, a frequency of monitoring data, battery capacity, transmission capability, etc.

The receiver 210 may include a first component for receiving Down Link (DL) signals from the e-Node B 101 to UE(s) 106 and a second component for receiving Up Link (UL) signals from the UE(s) 106 to the e-Node B 101.

The memory 215 may be used to store data obtained through the receiver 210. Furthermore, the memory 215 may have stored thereon instructions for analyzing the data received via the receiver 210 and determining whether to install a small cell base station at the target location 103. The memory 211 may be any one of, but not limited to, a volatile memory such as a static random access memory (SRAM), a dynamic random access memory (DRAM), a flash memory, a non-volatile memory such as a magnetic storage device including a hard disk, a floppy disk, an optical disc, etc.

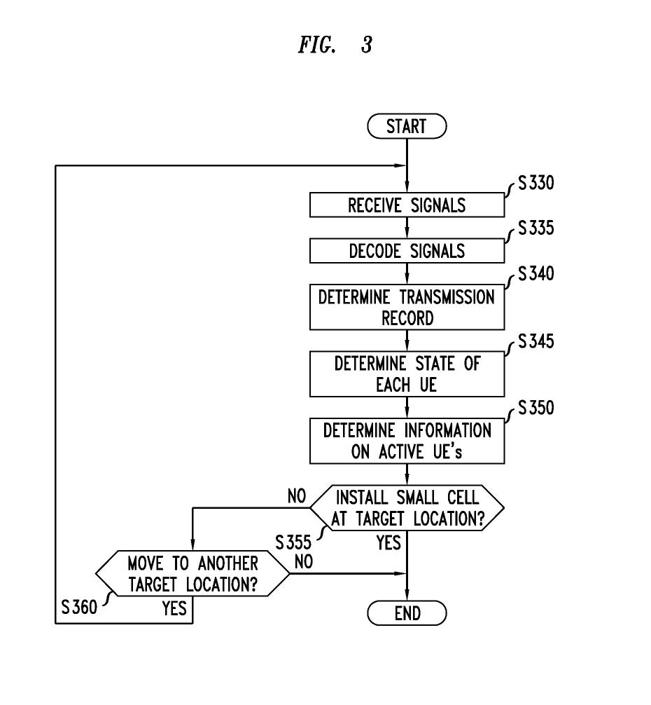

The monitoring device 105 further includes a processor 220 for carrying out the instructions, stored on the memory 215, for analyzing the data received via the receiver 210 and determining whether to install a small cell base station at the target location 103. The process of analyzing and determining will be further described below with reference to FIGS. 3-5.

The monitoring device 105 also includes a battery 225. The battery 225 may be any type of battery for enabling a device to operate for a period of time without a power connection to an AC power source. The battery 225 may be any one of, but not limited to, a rechargeable battery such as a lead-acid battery, a lithium-ion battery, a nickel-zinc battery, a primary cell battery such as an alkaline battery, a dry cell battery, a lithium battery, etc. Any other means for supplying power to the monitoring device 105 may also be used in place of and/or in conjunction with the battery 225.

In one example embodiment, the monitoring device 105 is a passive device and may not be capable of analyzing the data received via the receiver 210 and/or determine whether the target location 103 at which the monitoring device 105 is deployed, is an optimal location for installing a small cell base station. Accordingly, for a period of time during which the monitoring device 105 is at the target location 103, the monitoring device may passively monitor DL/UL signals and store the monitored value in the memory 215. After the period of time has passed, an operator may remove the monitoring device 105 from the target location 103 and connect the device to an external computer, retrieve the data from the memory of the monitoring device 105 and accordingly determine whether the target location 103 at which the monitoring device 105 was deployed, constitutes an optimal location for installing a small cell base station. Accordingly, in this example embodiment, the monitoring device 105 may be configured to be connected to such external computer, via for example a USB connection.

In one example embodiment, the monitoring device 105 may not be capable of analyzing the data received via the receiver 210 and/or determine whether the target location 103 at which the monitoring device 105 is deployed, is an optimal location for installing a small cell base station. However, the monitoring device 105 may be equipped with a transmitter such that the data received via the receiver 210 may be transmitted to an external computer, where the transmitted data is analyzed and based thereon it is determined whether the target location 103 at which the monitoring device 105 is deployed, constitutes an optimal location for installing a small cell base station or not. Any medium and/or type of communication between the monitoring device 105 and the external computer may be utilized.

Hereinafter, a process for analyzing data received by the receiver 210 and determining whether a location at which a monitoring device is deployed, constitutes an optimal location for installing a small cell base station will be described with reference to FIGS. 1-3.

As described above, the process may be implemented by the processor 220 of the monitoring device 210 or in the alternative may be implemented by a processor of an external computer connected to the monitoring device 105 or with which the monitoring device 105 communicates.

FIG. 3 is a flow chart describing a process for determining whether a target location is optimal for installing a small cell base station, according to an example embodiment.

At S330 the monitoring device 105, via the receiver 210, may receive (e.g., detect/observe) one or more of the physical control channels between the e-Node B 101 and one or more UEs such as UE(s) 106.

At S335, the monitoring device 105 may decode the one or more received physical control channels. The physical control channels may be any one of a Broadcast Control Channel (BCCH), which may be mapped to a Physical Broadcast Channel (PBCH) or a Physical Downlink Shared Channel (PDSCH), a Random Access Procedure, a Physical Downlink Control Channel (PDCCH), a Physical Hybrid-ARQ Indicator Channel (PHICH), a Physical Uplink Control Channel (PUCCH) and a demodulation reference signal (DM-RS). The decoding of each type of physical control channel is described below.

The monitoring device 105, via the processor 225, may decode the BCCH which is mapped to PBCH or PDSCH, as follows. The monitoring device 105 decodes the PBCH, using any known or to be developed decoding techniques/methods, to obtain Master Information Block (MIB) carried by the PBCH. MIB occupies first 4 Orthogonal Frequency Division Multiplexing (OFDM) symbols (e.g., 72 subcarriers) of second slot of a first sub frame of, for example an LTE frame. It contains downlink channel bandwidth in terms of resource blocks, PHICH configuration (duration and resource), System Frame Number, etc.

The monitoring device 105 decodes the PDSCH, using any known or to be developed decoding techniques/methods, to obtain System Information Block (SIB) carried by the PDSCH. SIB contains common and shared channel information and cell reselection parameters.

In one example embodiment, by decoding the BCCH, the monitoring device 105 may determine cell identification of a cell in which the UEs 106 are located and are being served by the e-Node B 101. If there are multiples UEs in different cells served by the e-Node B 101 and/or any other e-Node B, the monitoring device 105 determines the identification of each cell through decoding the BCCH. As will be discussed, the cell identification(s) along with additional parameters described below, will be used in decoding the PDCCH.

In one example embodiment, one such additional parameter is each UE 106's Cell Radio Network Temporary Identifier (C-RNTI). The monitoring device 105, via the processor 225, may decode the Random Access Procedure, as follows, in order to obtain each UE 106's C-RNTI.

The PDCCH does not explicitly address a UE using the UE's Cell Radio Network Temporary Identifier (C-RNTI). The PDCCH is implicitly encoded by scrambling the Cyclic Redundancy Check (CRC) with the UE's C-RNTI. As is known, the CRC is an error detecting code. When a UE attempts to connect to a network (e.g., when the UE is turned on), there are two random access procedures. One is a contention-based random access and the other is contention-free random access. In contention-based random access, a Random Access Channel (RACH) message 2 carries a temporary Radio Network Temporary Identifier (RNTI) from the serving e-Node B 101 to the served UE(s) 106. If there is no collision, this temporary RNTI is promoted to C-RNTI after message 4 and thus may be obtained by the monitoring device 105 when the e-Node B 101 and the UE 106 communicate.

Contention-free random access is often used during handoff of the UE between two e-Node Bs (e.g., when a UE 106 is handed off from the e-Node B 101 to the e-Node B 102). The allocated C-RNTI at the new e-Node B is carried in an encrypted message from the new e-Node B to the corresponding UE and thus may be obtained by the monitoring device 105. In one example embodiment, because a handoff is infrequent and bearer duration is small (e.g., average of tens of seconds), the search for the C-RNTI may or may not be ignored. If searched, given that C-RNTI has 16 bits, the range of possible values of C-RNTI is from 0 to 65536. However, in practice, the monitoring device 105 may typically need to search less than 1000 possibilities for the C-RNTI value because the number of gold codes used for generating a C-RNTI, which is an industry standard binary sequence, is limited due to PDCCH assignment procedure, as described in “LTE;

Evolved Universal Terrestrial Radio Access (E-UTRA); Physical layer procedures (3GPP S36.213, Section 9.1.1)”.

Having determined the cell identification(s) and the C-RNTI of the UE(s) 106 communicating with each e-Node B as observed by the monitoring device 105, the monitoring device 105 may determine another additional parameter in order to decode the PDCCH.

The other additional parameter may be referred to as a per-cell scrambling code. In one example embodiment, per-cell scrambling sequence is used for downlink transmission. The per-cell scrambling sequence may be pseudo-random, created using a length-31 Gold sequence generator. The per-cell scrambling sequence is initialized, at the start of each subframe, using the slot number within the radio frame, nₛ and a cell ID N^{cell}_{ID}. Cell ID N^{cell}_{ID} is determined from the decoded BCCH, as discussed above. The per-cell scrambling sequence may be created based on the following formula and thus may be determined by the monitoring device using the same:

$${c}_{init} = [ \frac{{n}_{s}}{2} ] {2}^{9} + {N}_{ID}^{cell} \qquad ( 1 )$$

Having determined the cell identification(s), the C-RNTI of each UE 106 and the per-cell scrambling sequence, the monitoring device 105 may need one other additional parameter, which may be referred to as the aggregation level of the PDCCH. However, because the aggregation level of the PDCCH may not be known, in one example embodiment, the monitoring device 105 may perform a blind decoding of the PDCCH. The monitoring device 105 may perform a blind decoding of the PDCCH in a similar manner as performed by each UE 106, since each UE 106 is also unaware of the aggregation level of the PDCCH as well. The blind decoding may be performed as follows.

Typically, one to three symbols are allocated for PDCCH. The number of symbols used for PDCCH is indicated in the Physical Control Format Indicator Channel (PCFICH). 36 Resource elements are used as one Control Channel Element (CCE). Number of CCEs for the PDCCH depends on the number of transmit antenna, bandwidth (total number of Physical Resource Blocks (PRB)s, resource elements used for PCFICH and a number of the PHICH groups. The number of the PHICH groups used in the cell depends on BW and a factor associated with broadcasting a signal.

For example, for a 10 MHz bandwidth, a PHICH with a spreading factor of 2 and 2 transmit antennas, CCEs available for PDCCH will be 6, 23 or 32 depending on the number of symbols (e.g., one, two or three symbols) used for PDCCH as signaled by PCFICH. Multiple CCEs can be aggregated to achieve different coding rate (1, 2, 4 or 8). Aggregation level required for a UE such as the UE 106 depends on the UE's channel conditions and message size.

A UE is allocated a candidate set of PDCCH channels for each aggregation level. The UE then blind decodes each of these possible candidates for each of the possible message formats to determine if it was allocated PDSCH or Physical Uplink Shared Channel (PUSCH) resources. When a UE, such as UE 106 attempts to decode all the PDCCHs that may be formed from the CCEs in each of its search space, a PDCCH channel is declared valid only by CRC check sum result.

In one example embodiment, the starting CCE index for the candidate set for each aggregation level changes for each UE 106 in each subframe. The set of PDCCH candidates that each UE 106 monitors is defined in terms of search spaces. A search space at an aggregation level is defined by a set of PDCCH candidates. The CCEs corresponding to a PDCCH candidate of a search space are given by a formula as described in “LTE; Evolved Universal Terrestrial Radio Access (E-UTRA); Physical layer procedures (3GPP S36.213, Section 9.1.1)”.

The search spaces may be UE specific or common to all UEs. The UE-specific and common-search spaces may overlap. In the UE specific search space, the UE will always search for DCI format 0 and 1A. These two formats may have the same size and may be distinguished with a flag in the message. In addition to these two formats, the UE may search for one other DCI format depending on its transmission mode configured by Radio Resource Control (RRC). DCI Formats 0, 1A, 3 and 3A may have the same size and differentiated by the identification (ID) used to scramble CRC (e.g., common CRC or C-RNTI of UE). The UE specific search space has a number of candidates 6, 6, 2, 2 for aggregation levels 1, 2, 3, 4 respectively. Common search space has 2, 2, candidates for aggregation levels 4, 8, respectively. Since two DCI format sizes are searched per aggregation level, total blind decoding done by the UE is 44 for LTE release 8/9. The total blind decoding by the UE is 60 for LTE release 10. One of the blind decodings may be declared as a valid (e.g., successfully decoded) PDCCH based on the CRC.

Upon a successful decoding of the PDCCH by the monitoring device 105, as described above, the monitoring device 105 obtains the following information embedded within the PDCCH. The monitoring device 105 obtains the DCI carried by the PDCCH, which is scrambled by a cell and subframe specific scrambling sequence to randomize inter-cell interference. The monitoring device 105 obtains UE-specific (e.g., UE 106 specific) downlink scheduling assignment. The monitoring device 105 obtains resource-block allocation indicating the resource blocks on which the UE(s) 106 should receive the PDSCH. The monitoring device 105 obtains UE-specific (e.g., UE 106 specific) modulation and coding scheme (5 bits) indicating a modulation scheme, a coding rate and a transport block size. The monitoring device 105 obtains UE-specific (e.g., UE 106 specific) Hybrid-ARQ process number used for soft combining. The monitoring device 105 obtains Identity (C-RNTI) of the UE 106 for which the PDSCH transmission is intended (16 bit), which is not explicitly transmitted but rather included in the CRC calculation. The monitoring device 105 obtains the UE 106 specific C-RNTI, when the e-Node B 101 is communicating with a single UE 106 (e.g., a unicast transmission).

In one example embodiment, with the successful transmission of the PDCCH, the monitoring device 105 further obtains uplink scheduling assignment for each UE 106 served by an e-Node B 101, resource block allocation, including hopping indication indicating resource blocks upon which the UE(s) 106 should transmit the PUSCH, Modulation and coding scheme including redundancy version (5 bit) providing the UE(s) 106 with information on the modulation scheme, the coding rate, and the transport block size. The UE 105 further obtains information on new data indicator, which indicates whether the UE 106 should transmit a new transport block or retransmit the previous transport block. Moreover, the UE 105 obtains information on blind decoding of PDCCH where the search space is a function of UE identity and subframe number.

In addition to the PDCCH, the monitoring device 105, via the processor 225, may decode the PHICH. The PHICH may contain information on successful/unsuccessful UL transmissions between the e-Node B 105 and the UE(s) 106 served by the e-Node B 105. In one example embodiment, the monitoring device 105, via the processor 225, may decode the PHICH, as follows.

The e-Node B 101 sends a HARQ indicator to each UE 106 to indicate ACK or NACK for data sent between the e-Node B 101 and each UE 106 using the UL shared channel (SCH). In one example embodiment, if the uplink transmission occurs in subframe n, the corresponding PHICH will be in subframe n+4. A PHICH group number and orthogonal sequence index within the group are derived from the lowest uplink PRB index in the first slot of the corresponding PUSCH transmission and the DM-RS cyclic shift, as described in “LTE; Evolved Universal Terrestrial Radio Access (E-UTRA); Physical layer procedures (3GPP S36.213, Section 9.1.1)”.

In addition to obtaining information on successful/unsuccessful UL transmission between the e-Node B 101 and each UE 106, in one example embodiment, the monitoring device 105, via the processor 225, may decode the PUCCH to obtain information on successful/unsuccessful DL transmission between the e-Node B 101 and each UE 106.

Accordingly, the monitoring device 105 decodes downlink control information carried by PUCCH and obtains information on one or more of a hybrid-ARQ ACK for received DL-SCH transport blocks, channel-state reports related to the downlink channel conditions used in assisting downlink scheduling and scheduling requests indicating that a terminal needs uplink resources for UL-SCH transmissions.

Furthermore, the monitoring device 105 may decode demodulation reference signals (DM-RSs) to validate that the monitoring device 105 is capable of hearing the actual uplink transmission. In one example embodiment, in order to decode DM-RS, several parameters are needed. Such parameters may include groupAssignmentPUSCH and Δss (available as a cell-specific 5-bit broadcast signaling parameter). Another parameter is a cyclicshift parameter provided by higher LTE layer. There are 8 values that a cyclicshift parameter may have. Accordingly, the monitoring device 105 may perform a blind decoding to determine the appropriate cyclicshift parameter. For example, the monitoring device 105 may cover all 8 possible values of the cyclicshift parameter. The monitoring device 105 may then decode the DM-RS signal with each possible parameter and determine a valid decoding based on a CRC.

As shown in FIG. 3, at S340 and based on the decoded physical control signals, the monitoring device 105, via the processor 220, may determine a transmission record associated with the e-Node B 101, as observed by the monitoring device 105, and the UE(s) 106 communicating with the e-Node B 101.

In one example embodiment, the transmission record may include information related to Timestamps, Cell Identification, C-RNTI of each UE 106, UL and DL transmission, Coding and Modulation Schemes, Transport block size, Resource Blocks allocated and success or failure of transmission between the e-Node B 101 and the UE(s) 106. In one example embodiment, the timestamps correspond to times at which the monitoring device 105 receives/detects various signals communicated between the e-Node B 101 and the UE(s) 106. The transmission record may be saved in a tabular format with the above information for each and every UE 106 that communicates with the e-Node B 101 or any other e-Node B serving within the geographical area 100 of FIG. 1, as observed by the monitoring device 105.

At S345, the monitoring device 105 may determine the RRC state of each UE 106 that communicates with each e-Node B, as observed by the monitoring device 105. Prior to describing how the monitoring device 105 may determine the RRC state of each UE 106, a description of the RRC states and transition from one to the other is provided first.

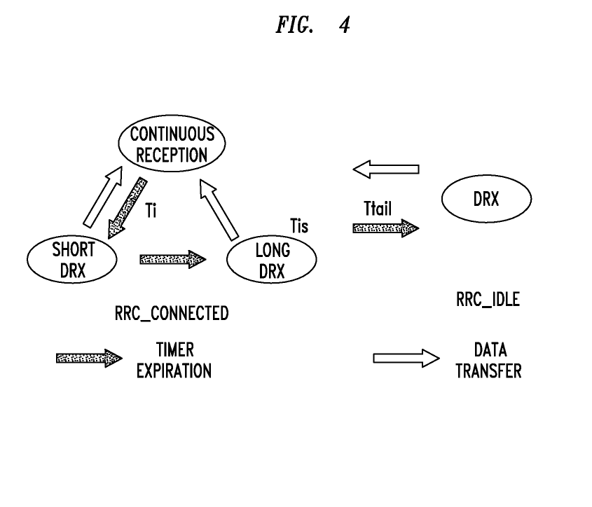

LTE communication standards provide two RRC states. One such state is referred to as RRC_CONNECTED while the other state is referred to as RRC_IDLE. FIG. 4 illustrates radio resource access states of a user equipment, according to one example embodiment.

As shown in FIG. 4, at the RRC_CONNECTED state, the UE 106 may be in one of three modes. The three modes may be referred to as the Continuous Reception mode, the Short Discontinuous Reception (DRX) mode, and the Long DRX mode. At the RRC_IDLE state, the UE 106 may only be in a DRX mode. DRX is adopted as an LTE standard for a UE, such as the UE 106 to “micro-sleep” so as to reduce power consumption of the UE 106 while providing high Quality of Service (QoS) and connectivity.

In one example embodiment, if the UE 106 is initially in the RRC_IDLE state and receives and/or sends one packet, regardless of the packet size, the state of the UE 106 is promoted from RRC_IDLE state to the RRC_CONNECTED state with a relatively stable delay. Upon being promoted to the RRC_CONNECTED state, the UE 106 enters the Continuous Reception mode by default and keeps monitoring the (PDCCH), which delivers control messages to the UE 106. The UE 106 may also initiate the DRX inactivity timer Ti, which is reset every time the UE 106 receives/sends a packet. Upon Ti's expiration without observing any data activity, the UE 106 enters the Short DRX mode.

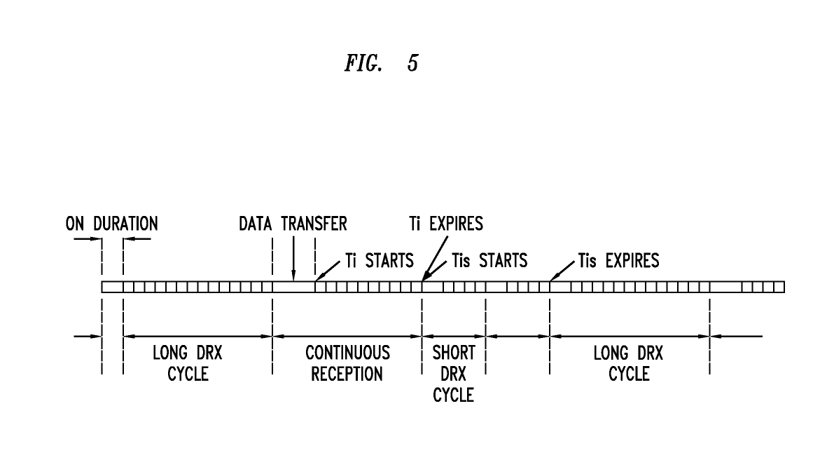

DRX in RRC_CONNECTED (e.g., short DRX and long DRC) and RRC_IDLE states have similar mechanisms, but different parameter settings. FIG. 5 illustrates transmission status of a user equipment during a connected radio resource control state, according to an example embodiment.

As shown in the example embodiment of FIG. 5, a DRX cycle includes an On Duration during which the UE 106 monitors PDCCH. Thereafter, the UE 106 rests for the rest of the cycle to save energy. The tradeoff between battery saving and latency is the guideline for determining the parameterization of DRX cycle. With a fixed On Duration, a longer DRX cycle reduces energy consumption of UE while increasing user-perceived delay and a shorter DRX cycle reduces the data response delay at the cost of more energy consumption. Short DRX and Long DRX modes, having the same On Duration and differing in cycle length, are intended to address these conflicting requirements.

When the UE 106 enters the Short DRX mode, A Short Cycle Timer Tis is started. Upon Tis's expiration, if there is no data activity (e.g., data transfer to or from the UE 106), the UE 106 switches to the Long DRX mode. If there is data activity, the UE 106 switches back to the Continuous Reception mode. Every time the UE 106 enters the Continuous Reception mode, when there is any detected data transfer, the UE 106 initiates a tail timer Ttail shown in FIG. 4. The timer Ttail may be reset every time a packet is sent/received by the UE 106. As shown in FIG. 5, Ttail may coexist with Ti and Tis.

In one example embodiment, when Ttail expires, the UE 106 switches from the RRC_CONNECTED state and enters the RRC_IDLE state. Accordingly, the allocated radio resource is released.

In one example embodiment, the timer values (e.g., Ti, Tis and Ttail) may be configured into the UE 106 and thus may be known to a service provider. In one example embodiment, the time values may be inferred from observing the UE 106 and its data activity.

Referring back to the determination of the RRC state, in one example embodiment, the monitoring device 105 may determine the RRC state of the each UE, such as the UE 106, based on the decoded PBCH and/or by observing the idle times between consecutive Medium Access Control (MAC) frames transmitted to and/or from each UE such as the UE 106.

In one example embodiment, the monitoring device 105 filters out inter-arrival MAC times, which are smaller than a threshold. For example, the monitoring device 105 may filter out inter-arrival MAC times that are less than 5 ms. However, the threshold may not be limited to 5 ms but rather may be a reconfigurable parameter that may take on any value based on empirical studies. The threshold may be programmed into the monitoring device 105.

The monitoring device 105 may then use a standard clustering algorithm to obtain timer values of the RRC state. The timer values may correspond to the cluster heads determined based on the clustering algorithm. In one example embodiment, the timer values and timestamps of frames can be used to determine which RRC state the UE 106 is currently at.

In one example embodiment and in order to improve the obtained timer values, the monitoring device 105 may keep timer values with minimal variance among them. The monitoring device 105 may then assign the timer values with minimal variance to the right timer based on their relative value.

At S350, the monitoring device 105 may determine information on active UEs such as the UE 106 communicating with each e-Node B such as e-Node B 101 and/or 102, as observed by the monitoring device 105. The monitoring device 105 may determine the information on the active UEs based on the transmission records and/or the RRC state of each EU. The information may be any one or more of the following.

In one example embodiment, by knowing the RRC state of each UE 106 and the transmission record described above, the monitoring device 105, via the processor 220, may determine an average number of active UEs for a given time period, as detected by the monitoring device 105. The given time period may be any one of a pre-defined set of time periods determined based on empirical studies. For example, particular time frames throughout a day (e.g., 6 AM-9 AM, 12:00 PM-2:00 PM, etc.), specific days (Mondays, Fridays, etc.), a particular week (e.g., last week of the month, etc.), an entire time period over which the monitoring device 105 is located at a target location 103, etc.

In one example embodiment, by knowing the RRC state of each UE 106, the monitoring device 105, via the processor 220, may determine a moving average number of active UEs for a select time period, as detected by the monitoring device 105. A select time period may be any time period over which information on the moving average number of active UEs is desired. For example, any time period (e.g., any hour, any day, any week, an entire time period over which the monitoring device 105 is located at a target location 103, etc.).

In one example embodiment, by knowing the RRC state of each UE 106, the monitoring device 105, via the processor 220, may determine an average number of active UEs for a given time period over a given geographical area, as detected by the monitoring device 105. The given time period may be as defined above. A geographical area may be the same as the geographical area 100 of FIG. 1 or may be any other (e.g., smaller) geographical area within the geographical area 100 of FIG. 1.

In one example embodiment, by knowing the RRC state of each UE 106, the monitoring device 105, via the processor 220, may determine a moving average number of active UEs for a given time period over a given geographical area, as detected by the monitoring device 105. The given time period may be the same as described above. The geographical area may be the same as described above.

In one example embodiment, by knowing the RRC state of each UE 106 and the transmission record, the monitoring device 105, via the processor 220, may determine a power distribution map associated with all the UEs 106 detected by the monitoring device 105. The power distribution map may provide information on the observed transmit power level of each detected UE 106. In one example embodiment, the map may be a 2-D map where the observed transmit power is expressed in dB units (e.g., on the horizontal axis of the 2-D map) and plotted versus the number of UEs at each of the observed transmit power levels (e.g., on the vertical axis of the 2-D map).

In one example embodiment, by knowing the RRC state of each UE 106 and the transmission record, the monitoring device 105, via the processor 220, may determine Down Link data volume per detected UE by the monitoring device 105. For example, the monitoring device 105 may determine the average Kbytes of data volume on the DL. The average data volume of the DL may be any one or more of an average DL data volume per UE 106 for a given time period, an aggregate DL data volume for the all the UEs 106, as observed by the monitoring device 105, over a given time period and an average DL data volume for all the UEs 106, as observed by the monitoring device 105 over a given time period. The given time period and the select time period may be the same as described above.

At S355 and based on the determined density information on the active UEs 106, the monitoring device 105, via the processor 220, may determine whether the target location 103 is an optimal location for installing the small cell base station. For example, target locations with large number of UEs and traffic volumes may be chosen for installing small cell base stations. In one example embodiment, the quality of service provided by the macro cell base station (e.g., e-Node B 101) at each target location may also be taken into consideration when determining whether such target location is an optimal location for installing the small cell base station.

In one example embodiment, a target location, from among possible target locations with the largest number of UEs may be selected for installing the small cell base station. In one example embodiment, a target location, from among possible target locations with the highest traffic volume may be chosen for installing a small cell base station. In one example embodiment, a target location, from among possible target locations with the highest quality of service provided by the macro cell base station may be chosen for installing a small cell base station. In one example embodiment, a weighted average of the above described factors (e.g., highest number of UEs, highest traffic volume and highest quality of service provided by the macro cell base station) may be taken into consideration when determining which one of the possible target locations is suitable for installing the macro cell base station. The weight corresponding to each parameter may be determined based on empirical studies.

In one example embodiment, an objective function may be defined for each target location. The objective function may be used to maximize/or minimize a numeric value of a linear function of two or more parameters. For example, given the parameters of number of UEs, traffic volume and quality of service at each target location, a linear combination of these parameters may be determined with a weight (either negative or positive, depending on design and system parameters) associated with each parameter. A target location for which the objective function results in the highest numeric value among all target locations may be determined as a suitable location for installing the small cell base station.

If at S355, the monitoring device 105 determines that the target location 103 is optimal, the process may end. However, if at S355 the monitoring device 105 determines that the target location 103 is not an optimal location the processor may proceed to S360.

At S360, in one example embodiment, an operator of the monitoring device may determine to move the monitoring device to another target location (e.g., the target location 104 shown in FIG. 1). If the monitoring device is moved to the other target location, the monitoring device may be configured to perform S330-S355 at the new target location. Otherwise, the process may end.

In one example embodiment, as also mentioned with respect to FIG. 1, there may be more than one target location and thus more than one monitoring device at each of the target locations. Accordingly, each monitoring device may determine information on the number of active UEs, as observed by the corresponding one of the monitoring devices, according to the process described with reference to FIG. 3.

Thereafter, the determination of each of the monitoring devices may be exported (e.g., either transmitted and/or downloaded) onto a central processor such as the central processor 109 shown in FIG. 1. A system operator, using the central processor 109, may perform a comparison of the information determined by each monitoring device and view the results of the comparison as a table, a histogram, a time-series map or a geo-map.

For example, using the central processor 109, the system operator may overlay the UE density information determined by each monitoring device as described above, over a geographical map, compare the DL traffic volume information determined by monitoring devices, compare the UL traffic volume information determined by monitoring devices, etc.

Based on the comparison, the system operator, or in the alternative an automated set of instructions executed by the central processor 109, may determine which one of the target locations at which a monitoring device has been deployed, constitutes an optimal location for installing a small cell base station. In determining the optimal location for installing the small cell base station, the traffic volume during the peak/off-peak periods may also be taken into consideration.

In one example embodiment, if an objective is to install K small cell base stations at possible P target locations, where K<P, then upon comparing the information determined by P monitoring devices at P target locations, the K best target locations may be chosen for installing the K small cell base stations. The determination of the K best target location may be based on the same parameters as described above with respect to selecting only one target location (e.g., target locations with the K highest number of UEs, K highest traffic volumes, K best quality of service provided by the macro cell base station(s), a weighted average of such factors, etc.).

Variations of the example embodiments are not to be regarded as a departure from the spirit and scope of the example embodiments, and all such variations as would be apparent to one skilled in the art are intended to be included within the scope of this disclosure.

For example, although an LTE system and associated components (e-Node Bs, LTE control channels, etc.,) have been used in describing the example embodiments above, the same methodology may be applied to other wireless communication systems including, but not limited to, universal mobile telecommunications system (UMTS), wideband code division multiple access (W-CDMA) system, etc.

What is claimed:

1. A device configured to determine whether to install a small cell base station at a target location, the device comprising:
a processor configured to,
determine a transmission record associated with communication between at least one macro cell base station and a plurality of user equipment (UEs), and
determine whether to install the small cell base station at the target location based on the transmission record and a connectivity state of each of the plurality of UEs.

2. The device of claim 1, wherein the processor is configured to determine the transmission record by,
decoding a plurality of control channels, and
obtaining information included in each of the plurality of control channels, the obtained information corresponding to the communication between the at least one macro cell base station and the plurality of UEs.

3. The device of claim 2, wherein the obtained information includes one or more of an identification of each of the plurality of UEs, an identification of a cell served by the macro cell base station, uplink and downlink transmissions between the at least one macro cell and the plurality of UEs, coding and modulation schemes for transmitting data between the at least one macro cell base station and the plurality of UEs, allocated resource blocks and success or failure of transmissions between the at least one macro cell base station and the plurality of UEs.

4. The device of claim 1, wherein
the processor is further configured to determine a density of active UEs from among the plurality of UEs, a map illustrating a power distribution of the plurality of UEs at the target location and a downlink data volume associated with the plurality of UEs at the target location, and
the processor determines whether to install the small cell base station at the target location based on the density of active UEs, the map and the downlink data volume.

5. The device of claim 4, wherein the density of active UEs is an average of the active UEs over at least one of a time period and a geographical area.

6. The device of claim 4, wherein the density of active UEs is a moving average of the active UEs over at least one of a time period and a geographical area.

7. The device of claim 4, wherein the downlink data volume is an average downlink data volume associated with each of the plurality of UEs over a time period.

8. The device of claim 4, wherein the downlink data volume is an average downlink data volume associated with all of the plurality of UEs over a time period.

9. The device of claim 1, wherein the device further comprises a receiver configured to receive signals transmitted between the at least one macro cell base station and the plurality of UEs, the receiver including a first component for receiving downlink signals transmitted from the at least one macro cell base station to each of the plurality of UEs and a second component for receiving uplink signals transmitted from each of the plurality of UEs to the at least one macro cell base station.

10. The device of claim 1, wherein the device further comprises a memory configured to store information related to the communication between the at least one macro cell base station and the plurality of UEs.

11. The device of claim 1, wherein the device further comprises a transmitter configured to transmit to a central processor at least one of,
information related to the communication between the at least one macro cell base station and the plurality of UEs, and
a result of determining whether to install the small cell base station at the target location.

12. A system comprising:
a plurality of devices, each of the plurality of devices being deployed at different respective target locations, each target location having an associated set of user equipment (UEs), each of the plurality of devices including a processor configured to,
determine a transmission record associated with communication between at least one macro cell base station and the associated set of UEs as well as a connectivity state of each of the plurality of UEs; and
a central processor configured to,
receive transmission records and the connectivity state of each of the plurality of UEs, from the plurality of devices, and
determine whether to install a small cell base station at one of the different target locations or another location, based on the received transmission records and the connectivity states of each of the plurality of UEs.

13. A method for determining whether to install a small cell base station at a target location, the method comprising:
determining a transmission record associated with communication between at least one macro cell base station and a plurality of user equipment (UEs); and
determining whether to install the small cell base station at the target location based on the transmission record and a connectivity state of each of the plurality of UEs.

14. The method of claim 13, wherein the determining includes,
decoding a plurality of control channels, and
obtaining information included in each of the plurality of control channels, the obtained information corresponding to the communication between the at least one macro cell base station and the plurality of UEs.

15. The method of claim 14, wherein the obtained information includes one or more of an identification of each of the plurality of UEs, an identification of a cell served by the macro cell base station, uplink and downlink transmissions between the at least one macro cell and the plurality of UEs, coding and modulation schemes for transmitting data between the at least one macro cell base station and the plurality of UEs, allocated resource blocks and success or failure of transmissions between the at least one macro cell base station and the plurality of UEs.

16. The method of claim 13, further comprising:
determining a density of active UEs from among the plurality of UEs, a map illustrating a power distribution of the plurality of UEs at the target location and a downlink data volume associated with the plurality of UEs at the target location, wherein
the determining whether to install the small cell base station at the target location, determines whether to install the small cell base station at the target location based on the density of active UEs, the map and the downlink data volume.

17. The method of claim 13, further comprising:
receiving signals transmitted between the at least one macro cell base station and the plurality of UEs, wherein the receiving includes
first receiving downlink signals transmitted from the at least one macro cell base station to each of the plurality of UEs, and
second receiving uplink signals transmitted from each of the plurality of UEs to the at least one macro cell base station.

18. The method of claim 13, further comprising:
storing information related to the communication between the at least one macro cell base station and the plurality of UEs.

19. The method of claim 13, further comprising:
transmitting to a central processor at least one of,
information related to the communication between the at least one macro cell base station and the plurality of UEs, and
a result of determining whether to install the small cell base station at the target location.
